(19) United States
(12) Patent Application Publication
(10) Pub. No.: US 2017/0075113 A1
(43) Pub. Date: Mar. 16, 2017

(54) ON-BOARD HEAD-UP DISPLAY DEVICE, DISPLAY METHOD, AND CAR COMPRISING THE ON-BOARD HEAD-UP DISPLAY DEVICE

(71) Applicant: BOE TECHNOLOGY GROUP CO., LTD., Beijing (CN)

(72) Inventors: Naifu Wu, Beijing (CN); Wei Wei, Beijing (CN); Kun Wu, Beijing (CN); Tao Wang, Beijing (CN); Bei Niu, Beijing (CN)

(21) Appl. No.: 15/183,136

(22) Filed: Jun. 15, 2016

(30) Foreign Application Priority Data
Sep. 11, 2015 (CN) 201510579360.6

(51) Int. Cl. G02B 27/00; B60K 35/00; G01C 21/36; G02B 27/01

(52) U.S. Cl. CPC G02B 27/0093; G02B 27/0103; G02B 27/0179; B60K 35/00; G01C 21/3632; G02B 2027/014; G02B 2027/0181; G02B 2027/0134; G02B 2027/0141; B60K 2350/1076; B60K 2350/2052

(57) ABSTRACT

An on-board head-up display device includes: a navigation module, an eye position detecting module, an image processing module and an image display module; the navigation module is configured to input navigation data and a spatial position coordinate of a car with respect to a position where navigation data is to be executed, to the image processing module; the eye position detecting module is configured to detect a spatial position coordinate of the left and right eyes of the driver with respect to the car; the image processing module is configured to form display information; and the image displaying module, configured to display the display information in image in front of the eyes of the driver, and the image is on a line between the eyes of the driver and the position where the navigation information to be executed.

### TECHNICAL FIELD

Embodiments of the present disclosure relate to an on-board head-up display device, a display method, and a car including the on-board head-up display device.

### BACKGROUND

An on-board head-up display device is a driving assistance device which displays navigation information for the car driving (for example, the junction direction information) in front of the eyes of the driver by using the optical means.

### SUMMARY

At least one embodiment of the present disclosure provides an on-board head-up display device, which comprising a navigation module, an eye position detecting module, an image processing module and an image display module, wherein:

the navigation module is configured to input to the image processing module navigation data and a spatial position coordinate of the car with respect to a position where navigation information to be executed;

the eye position detecting module is configured to detect a spatial position coordinate of the left and the right eyes of the driver with respect to the car;

the image processing module connected to the navigation module and the eye position detecting module respectively, and configured to load the spatial position coordinate of the car with respect to the position where the navigation information is to be executed, the spatial position coordinate of the left and the right eyes of the driver with respect to the car onto the navigation data, so as to form a display information; and

the image display module, connected to the image processing module and configured to display the display information in image in front of eyes of the driver, wherein the image is on a line between the eyes of the driver and the position where the navigation information is to be executed.

At least one embodiment of the disclosure provides a display method, comprising:

acquiring a spatial position coordinate of a car with respect to a position where the navigation information is to be executed, a spatial position coordinate of the left and right eyes of a driver with respect to the car, and navigation data;

loading the spatial position coordinate of the car with respect to the position where the navigation information is to be executed and the spatial position coordinate of the left and right eyes of a driver with respect to the car onto the navigation data, so as to form display information; and

displaying the display information in front of the eyes of the driver in image, wherein the image is on a line between the eyes of the driver and the position where the navigation information to be executed.

At least one embodiment of the present discloses a car including on-board head-up display device as described above.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is a schematic block diagram of an on-board head-up display device according to one embodiment of the disclosure;

FIG. 2 is a first image displayed by the image display module according to one embodiment of the disclosure;

FIG. 3 is a second image displayed by the image display module according to one embodiment of the disclosure;

FIG. 4 is a first schematic view of an image processing module and an image display module according to one embodiment of the disclosure;

FIG. 5 is a second schematic view of an image processing module and an image display module according to one embodiment of the disclosure; and

FIG. 6 is a flow chart of a display method according to one embodiment of the disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

The inventors of the embodiments of the present disclosure found that, a conventional on-board head-up display device displays navigation information on the front windshield of the car fixedly in a manner of 2D image, and the 2D images are presented in front of the driver. When the head of the driver moves around (for example, the head of the driver moves around due to car bumping), eyes of the driver move around correspondingly. Thus, eyes of the driver, the 2D image, and position where the navigation information is to be presented are not over a straight line, such that the 2D image observed by the driver is not over the position where the navigation information is to be executed. Therefore, the navigation information provided to the driver by a conventional on-board head-up display device is not accurate enough when the head of the driver moves around.

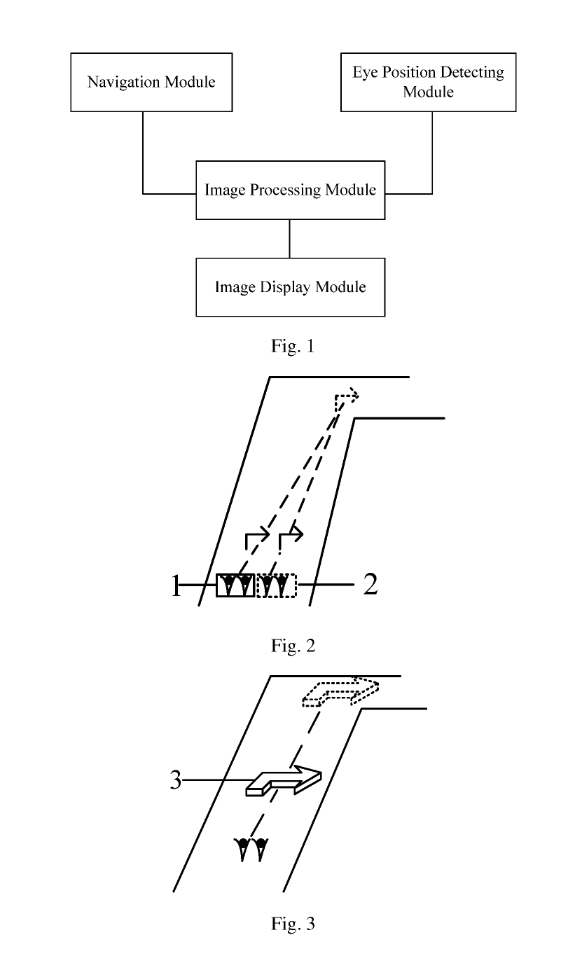

One embodiment of the disclosure provides an on-board head-up display device, as illustrated in FIG. 1, which comprises a navigation module, an eye-position detecting module, an image processing module, and an image display module. Each of the components will be described hereinafter. These modules can be connected through in a wired manner or in a wireless manner so as to communicate, that is, transfer signals among them. The wireless manner comprises WIFI, Bluetooth, or the like; the wired manner comprises the electrical or optical wires.

The navigation module is configured to input, into the image processing module, navigation data and the spatial position coordinate of a car in a first coordinate system with respect to the position where the navigation information is to be executed (for example, a turn-right junction). In the first coordinate system, the position where the navigation information is to be executed is selected as the origin, the advancing direction of the car is selected as the X-axis direction, the horizontally rightward direction of the car is selected as the Y-axis direction, and the upright direction of the car is selected as the Z-axis direction. For example, when the navigation data is “turn right at the junction 200 meters ahead”, and the spatial position coordinate of the car with respect to the turning-right junction ahead is (0, −200, 0), the navigation module can input the navigation data and the spatial position coordinate to the image processing module. The navigation module can comprises a navigation IC or chip, which can be adapted to the Global Position System (GPS) of the United States, the BeiDou Navigation Satellite System (BDS) of China, or the like system and may further be adapted to use mobile communication signals, WIFI signals or the like for improving positioning effects.

The eye position detecting module is configured to detect the spatial position coordinate of the left and right eyes of the driver in the second coordinate system with respect to the car. For example, the eye position detecting module comprises a camera mounted inside the car, and this camera is configured to collect the image of the head of the driver (i.e., the image of eyes of the driver) and obtain the positions of the eyes through data analysis, so as to detect in real-time the spatial position coordinate of the left and right eyes of the driver with respect to the car; in this situation, the camera can possess data processing and analyzing function. In another example, the eye position detecting module may further comprise a processor (e.g., DSP, CPU or the like) in addition to the camera, and this processor can cooperate with the camera to perform the operation of eye positioning. The camera can comprises a CMOS or CCD image chip. In the second coordinate system, the position of the camera is taken as the origin, the advancing direction of the car is taken as the X-axis direction, the horizontally rightward direction is taken as the Y-axis direction, and the upright direction of the car as the Z-axis direction. In one example, the spatial position coordinate of the left and right eyes of the driver includes the combination of the spatial position coordinate of the left eye and the spatial position coordinate of the right eye; in another example, the spatial position coordinate of the left and right eyes of the driver includes the spatial position coordinate of the central point of the line connecting the eyes of the driver, and the spatial position coordinate of the left eye and the spatial position coordinate of the right eye can be obtained through an experienced factor (e.g., an average value of the distance between the eyes of human), that is, the central point can be considered as being equivalent to the left and right eyes in the device and method of the embodiments of the present disclosure.

The image processing module is connected to both the navigation module and the eye position detecting module, respectively, and is configured to load the spatial position coordinate of the car with respect to the position where navigation information is to be executed and the spatial position coordinate of the left and right eyes of the driver with respect to the car onto the navigation data so as to form display information. For example, if the navigation data is “turn right at the junction 200 meters ahead” or the like, the display information is an image of arrow indicating turning-right. The image processing module can be embodied at least partially in hardware, firmware or software, and for example, the image processing module may comprises a memory, a processor, and a computer executable program stored in the memory and capable of be executed by the processor to perform the function of image processing.

The image display module is connected to the image processing module and is configured to display the display information in image in front of the eyes of the driver. The image is on a line between the eyes of the driver and the position where the navigation information is to be executed. For example, when the navigation data is “turn right at the junction 200 meters ahead”, as illustrated in FIG. 2, the image processing module displays an arrow in image indicating turning-right in front of the initial position 1 of the eyes of the driver. The original position 1 of the eyes of the driver, the arrow indicating turn-right, and the turning-right junction are over one straight line, and the arrow indicating turning-right seen by the driver is disposed over the turning-right junction, that is, overlap with the turning-right junction. When the head of the driver moves around, the eyes of the driver moves around accordingly. For example, as illustrated in FIG. 2, when the eyes of the driver moves rightward away from the initial position 1 of the eyes to a position 2 later, the arrow indicating turning-right is moved rightward accordingly, such that the position 2 after movement, the arrow indicating turning-right, and the turning right junction are on one straight line again, and the arrow indicating turning-right seen by the driver is always disposed over the turning-right junction.

In the on-board head-up display device according to the embodiment of the disclosure, the navigation module inputs or uploads the navigation information and the spatial position coordinate of the car with respect to the position where the navigation information is to be executed onto the image processing module, the eye position detecting module detects the spatial position coordinate of the left and right eyes of the driver with respect to the car, and the image processing module loads the spatial position coordinate of the car with respective to the position where the navigation information is to be executed and the spatial position coordinate of the left and right eyes of the driver with respect to the car onto the navigation data so as to produce display information, and the image display module displays the display information in image in front of the eyes of the driver, the image is on a line between the eyes of the driver and the position where the navigation information to be executed. When the head of the driver moves around, the eyes of the driver move around accordingly. As the eye position detecting module can detect real change in position of the eyes of the driver, and feed the changes back to the image processing module, such that the eyes of the driver, the image displaying the navigation information and the position where the navigation information to be executed are over one straight line, thereby the image displaying the navigation information observed by the driver is always disposed over (overlaps) the position where the navigation information is to be executed. Thus, even during the head of the driver moving around, the on-board head-up display device according to the embodiments of the present disclosure can provide accurate navigation information to the driver.

In one embodiment of the present disclosure, the navigation information can be displayed in a manner of 3D image. For example, as illustrated in FIG. 3, when the navigation data is “turn right at the junction 200 meters ahead”, the turning right indicator is a 3D turning right indicator 3, the size of which will change as the distance between the car and the turning right junction changes (for example becoming bigger and bigger as approaching the position where the navigation information is to be executed), so as to simulate the real scene. Thereby, the on-board head-up display device according to the embodiments of the present disclosure can provide direct and stereo navigation information to the driver.

In one embodiment of the present disclosure, the image processing module and the image displaying module can be implemented in two manners as follow for example.

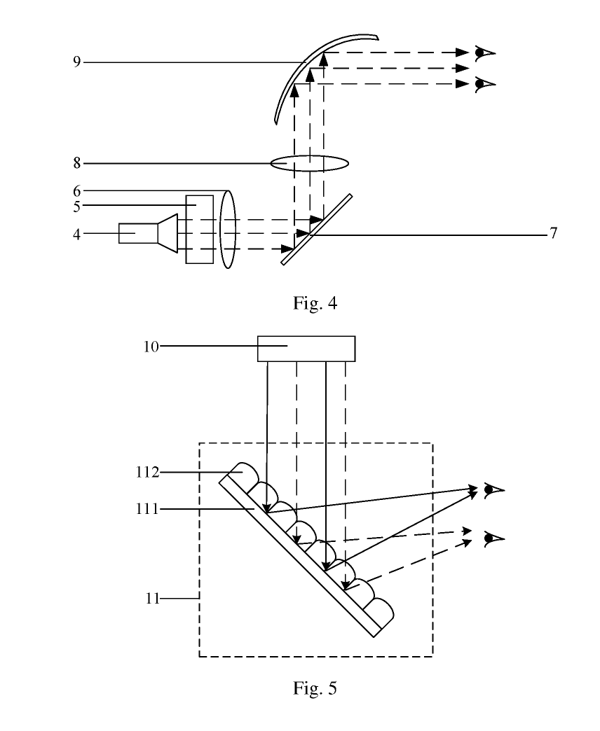

As illustrated in FIG. 4, the image processing module comprises a spatial light modulator 4. The spatial light modulator 4 is connected to the navigation module and the eye position detecting module, respectively. The spatial light modulator 4 is configured to load the spatial position coordinate of the car with respect to the position where the navigation information is to be executed and the spatial position coordinate of the left and right eyes of the driver with respect to the car onto an optical data field of the navigation information so as to form display information.

Further, as illustrated in FIG. 4, the image display module comprises a holographic lens 5 disposed vertically, a first collimator lens group 6 disposed vertically, a reflective mirror 7 disposed obliquely, a second collimator lens group 8 disposed horizontally, and a concave mirror 9; the reflective mirror 7 is tilted at an angle of 45° with respect to the axis of the first collimator lens group 6, the holographic lens 5 is disposed at the light emitting side of the spatial light modulator 4, and is configured to synthesize, from the display information, a 3D image with phase information and amplitude information. The holographic lens 5, the first lens group 6, the reflective mirror 7, the second lens group 8 and the concave mirror 9 are disposed subsequently along the light transmitting direction, and the concave mirror 9 is configured to reflect the light into the eyes of the driver. Thus, the light carrying display information passes through the holographic lens 5 and then passes through the first collimator lens group 6, and then is collimated to produce light propagating horizontally rightward. Then, the collimated light propagating horizontally rightward will be reflected by the reflective mirror 7 and will become a collimated light propagating upward, that is, is deflected by 90°. Subsequently, the collimated light propagating upward will be corrected by the second collimator lens group 8 so as to be kept in the state of being collimated. Next, the collimated light after correction will be reflected to the eyes of the driver by the concave mirror 9, such that the driver can see the navigation information in front of him or her in a manner of 3D image.

In one embodiment of the present application, the concave mirror 9 is a transflective concave mirror. The transflective concave mirror reflects the light from the second collimator lens group 8 and transmits light from the front of the car and incident to this transflective concave mirror. So, the driver can see the navigation information in a manner of 3D image and the road conditions in front of the car at the same time. Safety thereby can be improved during driving.

As illustrated in FIG. 5, the image processing module comprises a projector, e.g., an LCD projector 10. The LCD projector 10 is connected to the navigation module and the eye position detecting module, respectively. The LCD projector is configured to process the navigation data on the basis of the spatial position coordinate of the car respect to the position where the navigation information is to be executed and the spatial position coordinate of the left and right eyes of the drive with respect to the car, so that adjacent pixel columns in the LCD projector display left-eye image and right-eye image, respectively. The left-eye image and the right-eye image constitute the display information for realizing 3D display effect finally.

Further, as illustrated in FIG. 5, the image processing module comprises a light splitting screen 11, which is disposed at the light emitting side of the LCD projector 10 and is configured to reflect light from the pixel columns for displaying the left-eye image to the left eye of the driver, and to reflect light from the pixel columns for displaying the right-eye image to the right eye of the driver. Thus, the navigation information displayed in a manner of 3D image can be finally combined in the brain of the driver on the basis of the left-eye image seen by the left eye and the right-eye image seen by the right eye to produce the 3D feeling.

In one embodiment of the present disclosure, as illustrated in FIG. 5, the light-splitting screen 11 comprises a reflecting sheet 111 and a lenticular lens film 112 disposed on the reflecting sheet 111. Thus, the light incident on the light splitting screen 11 from the pixel columns will be reflected by the reflective sheet 111 and will be modulated by the lenticular lens film 112 such that light from the pixel columns for displaying the left-eye image enters the left eye of the driver and light from the pixel columns for displaying the right-eye image enters the right eye of the driver.

In one embodiment of the present disclosure, for example, the reflective sheet 111 is a transflective sheet which can reflect light from the pixel columns and transmit light from the front of the car. Thus, the driver can see both the navigation information in a manner of 3D image and the road conditions in front of the car at the same time. Safety thereby can be improved during driving.

It should be noted that, the image processing module and the image display module can be implemented in manners other than the manners described above. One of ordinary skill of the related art can select the manner for implementing the image processing module and the image display module according to actual requirement. For example, the image display module may be a transparent display embodied by the way of LCD, OLED, or the like.

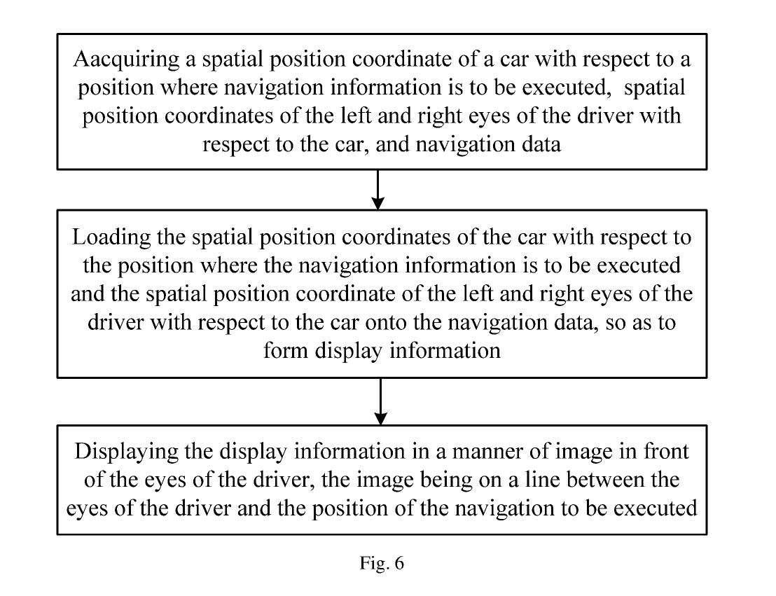

At least one embodiment of the present disclosure provides a display method, as illustrated in FIG. 6, the display method comprising the following operations:

S1: acquiring a spatial position coordinate of a car with respect to a position where the navigation information is to be executed, a spatial position coordinate of the left and right eyes of the driver with respect to the car, and navigation data;

S2: loading the spatial position coordinate of the car with respect to the position where the navigation information is to be executed and the spatial position coordinate of the left and right eyes of the driver with respect to the car onto the navigation data, so as to form display information; and

S3: displaying the display information in image in front of the eyes of the driver, the image being on a line between the eyes of the driver and the position where the navigation is to be executed.

Contents and functions of the method have been described in the embodiments of the present disclosure, and will not be repeated in detail here any more.

In the display method according to embodiments of the present disclosure, the spatial position coordinate of the car with respect to the position where the navigation information to be executed is acquired, the spatial position coordinate of the left and right eyes of the driver with respect to the car are acquired, and the navigation data are acquired as well. Then, the spatial position coordinate of the car with respect to the position where the navigation information is to be executed and the spatial position coordinate of the left and right eyes of the driver with respect to the car are loaded onto the navigation data so as to form display information. The display information is displayed in image in front of the eyes of the driver, and the image is on a line between the eyes of the driver and the position where the navigation is to be executed. When the eyes of the driver moves around accordingly as the head of the driver moves around, the eye position detecting module can detect changes in eye position of the driver in real time, and feed the changes back to the image processing module, so as to allow the eyes of the driver, the image displaying the navigation information, and the positions where the navigation data is to be executed are on one straight line all the time, such that the image displaying the navigation information is always on the position where the navigation data is to be executed. Thereby the display method according to embodiments of the disclosure can provide accurate navigation information to the driver during the head of the driver moving around.

At least one embodiment of the present disclosure provides a car including the on-board head-up display device, the on-board head-up display device comprising a navigation module, an eye position detecting module, an image processing module and an image display module, wherein:

the navigation module is configured to input to the image processing module navigation data and a spatial position coordinate of the car with respect to a position where navigation information to be executed;

the eye position detecting module is configured to detect a spatial position coordinate of the left and the right eyes of the driver with respect to the car;

the image processing module connected to the navigation module and the eye position detecting module respectively, and configured to load the spatial position coordinate of the car with respect to the position where the navigation information is to be executed, the spatial position coordinate of the left and the right eyes of the driver with respect to the car onto the navigation data, so as to form a display information; and

the image display module, connected to the image processing module and configured to display the display information in image in front of eyes of the driver, wherein the image is on a line between the eyes of the driver and the position where the navigation information is to be executed.

The car including such an on-board head-up display device can provide accurate navigation information to the driver, even during the head of the driver moving around.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201510579360.6 filed on Sep. 11, 2015, the disclosure of which is hereby entirely incorporated by reference as a part of the present disclosure.

What is claimed is:

1. An on-board head-up display device, comprising a navigation module, an eye position detecting module, an image processing module, and an image display module; wherein:
the navigation module is configured to load navigation data and a spatial position coordinate of a car with respect to a position where navigation information is to be executed onto the image processing module;
the eye position detecting module is configured to detect a spatial position coordinate of the left and the right eyes of a driver with respect to the car;
the image processing module is connected to the navigation module and the eye position detecting module respectively, and is configured to load the spatial position coordinate of the car with respect to the position where the navigation information is to be executed as well as the spatial position coordinate of the left and the right eyes of the driver with respect to the car onto the navigation data, so as to form display information; and
the image display module is connected to the image processing module and configured to display the display information in image in front of eyes of the driver, wherein the image is on a line between the eyes of the driver and the position where the navigation information is to be executed.

2. The on-board head-up display device according to claim 1, wherein the image processing module comprises a spatial light modulator, which is connected to the navigation module and the eye position detecting module, respectively, and is configured to load the spatial position coordinate of the car with respect to the position where the navigation information is to be executed and the spatial position coordinate of the left and right eyes of the driver with respect to the car onto an optical data field of the navigation information so as to form the display information.

3. The on-board head-up display device according to claim 2, wherein the image display module comprises a holographic lens which is disposed on a light emitting side of the spatial light modulator and is configured to synthesize a 3D image with phase information and amplitude information from the display information.

4. The on-board head-up display device according to claim 3, wherein the image display module further comprises a collimator lens group and a concave mirror, the holographic lens, the collimator lens group and the concave mirror are disposed in sequence along a direction in which light transmits, and the concave mirror is configured to reflect light from the collimator lens group to the eyes of the driver.

5. The on-board head-up display device according to claim 4, wherein the concave mirror is a transflective concave mirror, which reflects light from the collimator lens group to the eyes of the driver, and also transmits light from the front of the car to the eyes of the driver.

6. The on-board head-up display device according to claim 5, wherein the collimator lens group comprises a first collimator lens group and a second collimator lens group, a reflective mirror is disposed between the first collimator lens group and the second collimator lens group, the second collimator lens group is disposed between the reflective mirror and the concave mirror, the reflective mirror is configured to defect light from the first collimator lens group by 90° and the defected light passes through the second collimator lens group and transmits to the transflective concave mirror.

7. The on-board head-up display device according to claim 5, wherein the image processing comprises an LCD projector which is connected respectively to the navigation module and the eye position detecting module, and is configured to process the navigation data on basis of the spatial position coordinate of the car with respect to the position where the navigation information is to be executed and the spatial position coordinate of the eyes of the driver with respect to the car, so as to make adjacent pixel columns of the LCD projector respectively display a left-eye image and a right-eye image, which constitute the display information.

8. The on-board head-up display device according to claim 7, wherein the image display module comprises a light splitting screen, which is disposed at a light emitting side of the LCD projector and is configured to reflect light from pixel columns for displaying the left-eye image to the left eye of the driver and reflect light from pixel columns for displaying the right-eye image to the right eye of the driver.

9. The on-board head-up display device according to claim 8, wherein the light splitting screen comprises a reflective sheet and a lenticular lens film disposed on the reflective sheet.

10. The on-board head-up display device according to claim 9, wherein the reflective sheet is a transflective sheet which reflects light from the pixel columns to the eyes of the driver and transmits light from the front of the car to the eyes of the driver at the same time.

11. A display method, comprising:
acquiring a spatial position coordinate of a car with respect to a position where navigation information is to be executed, a spatial position coordinate of the left and right eyes of the driver with respect to the car, and navigation data;
loading the spatial position coordinate of the car with respect to the position where the navigation information is to be executed and the spatial position coordinate of the left and right eyes of the driver with respect to the car onto the navigation data, so as to form display information; and
displaying the display information in image in front of the eyes of the driver, the image being on a line between the eyes of the driver and the position where the navigation is to be executed.

12. The display method according to claim 11, wherein acquiring the spatial position coordinate of the left and right eyes of the driver with respect to the car comprises:
detecting the spatial position coordinate of the left and right eyes of the driver with respect to the car by an eye position detecting module, respectively.

13. The display method according to claim 11, wherein the display information is displayed in a manner of 3D image.

14. A car comprising the on-board head-up display device according to claim 1.
